(19) United States
(12) Patent Application Publication
(10) Pub. No.: US 2017/0066277 A1
(43) Pub. Date: Mar. 9, 2017

(54) GREETING CARD

(71) Applicants: Paige Cecchi, Madison, CT (US); Michael Cecchi, Longboat Key, FL (US); Lauren Miele, Ossining, NY (US)

(72) Inventors: Paige Cecchi, Madison, CT (US); Michael Cecchi, Longboat Key, FL (US); Lauren Miele, Ossining, NY (US)

(21) Appl. No.: 15/245,763

(22) Filed: Aug. 24, 2016

Related U.S. Application Data
(60) Provisional application No. 62/214,599, filed on Sep. 4, 2015.

(51) Int. Cl. B42D 15/04

(52) U.S. Cl. CPC B42D 15/045; B42D 15/042

(57) ABSTRACT

A greeting card, the greeting card comprising: a left side; a fold abutting the left side; a right side abutting the fold; an attachment means located on the left side or right side; a smoking related product configured to removably attach to the attachment means. A greeting card, the greeting card comprising: an outer greeting card, the outer greeting card comprising: a left side; a fold abutting the left side; a right side abutting the fold; a greeting card insert configured to generally fit inside the outer greeting card, the greeting card insert comprising: an attachment means, the attachment means configured to hold a smoking related product. A greeting card insert, the greeting card insert comprising: a generally rectangular card stock; an attachment means located on the generally rectangular card stock, the attachment means configured to hold a smoking related product.

### CROSS-REFERENCES

This patent application claims the benefit of U.S. Provisional Patent Application No. 62/214,599 by inventor Paige Cecchi and Lauren Miele entitled “GREETING CARD”, filed on Sep. 4, 2015, and which provisional application is fully incorporated by reference herein.

### TECHNICAL FIELD

The disclosed invention relates to a greeting card, and more particularly to a greeting card for use with smoking related products.

### BACKGROUND

Currently, there are many different types of generic greeting cards in the marketplace. They are used for many occasions such as birthdays, anniversaries, graduation, weddings and the like. Smoking related products are seeing resurgence. No known greeting cards include smoking related products.

Thus there is a need for an invention that overcomes the above listed and other disadvantages.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 shows a front view of one embodiment of the greeting card;

FIG. 2 shows a front view of another embodiment of the greeting card;

FIG. 3 shows a front view of another embodiment of the greeting card;

FIG. 4 shows a front view of another embodiment of the greeting card;

FIG. 5 shows a front view of another embodiment of the greeting card;

FIG. 6 shows a front view of another embodiment of the greeting card;

FIG. 7 shows a perspective view of another embodiment of the greeting card with an inner card;

FIG. 8 shows a perspective view of another embodiment of the greeting card;

FIG. 9 is an embodiment of a greeting card insert;

FIG. 10 is another embodiment of a greeting card insert;

FIG. 11 is another embodiment of a greeting card insert;

FIG. 12 is another embodiment of a greeting card insert; and

FIG. 13 is another embodiment of a greeting card insert.

### SUMMARY OF THE INVENTION

The invention relates to a greeting card, the greeting card comprising: a left side; a fold abutting the left side; a right side abutting the fold; an attachment means located on the left side or right side; a smoking related product configured to removably attach to the attachment means.

The invention also relates to a greeting card, the greeting card comprising: an outer greeting card, the outer greeting card comprising: a left side; a fold abutting the left side; a right side abutting the fold; a greeting card insert configured to generally fit inside the outer greeting card, the greeting card insert comprising: an attachment means, the attachment means configured to hold a smoking related product.

In addition, the invention relates to a greeting card insert, the greeting card insert comprising: a generally rectangular card stock; an attachment means located on the generally rectangular card stock, the attachment means configured to hold a smoking related product.

### DETAILED DESCRIPTION

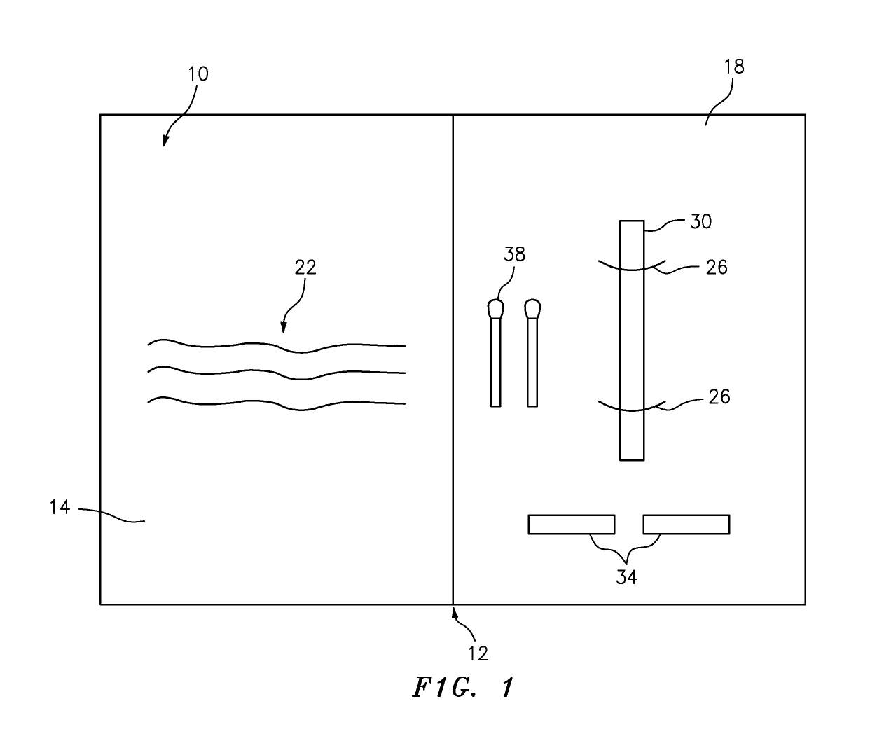

FIG. 1 shows one embodiment of the greeting card 10. The card may have a fold 12 which may be boundary between the left side 14 and a right side 18. The card may be closed so that the left side 14 and right side 18 come together when card is folded closed about the fold 12. A preprinted greeting 22 may be located on the left side or right side. One or more loops 26 attached to the card 10 may be located on the left 14 or right side 18 of the card. The loops 26 may be made out of an elastic material, and may be attached to the card via adhesive, staple, other fasteners, or the card may have a pair of small holes to allow each end of the loop to go through the hole and a backing larger than the hole may be attached to each end of the loop to hold the loop in placed with respect to the holes. The loops 26 may be configured to hold a cigarette 30. The cigarette 30 may be a tobacco cigarette, hand rolled cigarette, marijuana cigarette, or any other similarly shaped item. The card may have one or more match striking surfaces 34. Matches 38 may be provided with the greeting card 10. Since matches and match striking surfaces may be hazardous when mailed together, the matches may be enclosed in a container or baggie.

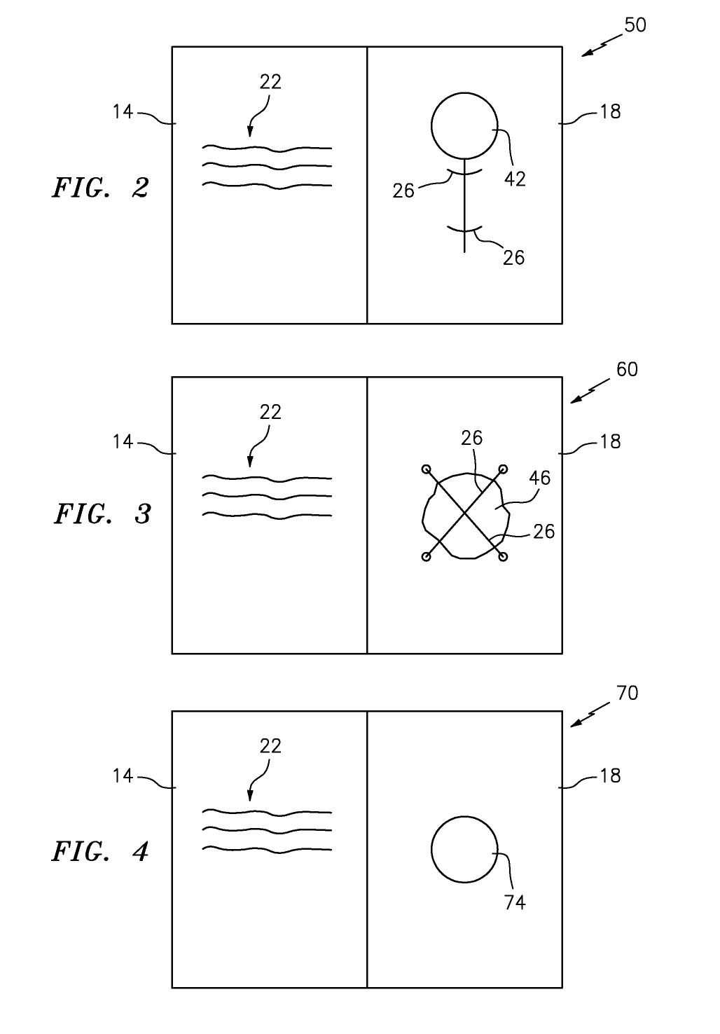

FIG. 2 shows another embodiment of the greeting card 50. In this embodiment, the loops 26 are configured to hold another item 42, such as a lollipop.

FIG. 3 shows another embodiment of the greeting card 60. In this embodiment, the loops 26 may be elongated and elastic, in order to better hold other shaped items 46, such as a baggie of tobacco or marijuana.

FIG. 4 shows another embodiment of the greeting card 70. In this embodiment, instead of loops 26, a sticky or tacky surface 74 is on one side of the card 70. The sticky or tacky surface 74 may have a removable paper or other material covering the surface 74 in order to preserve the sticky or tacky properties until ready for use. The sticky or tacky surface 74 may be used to hold plastic baggies filed with tobacco, marijuana, or edible treats.

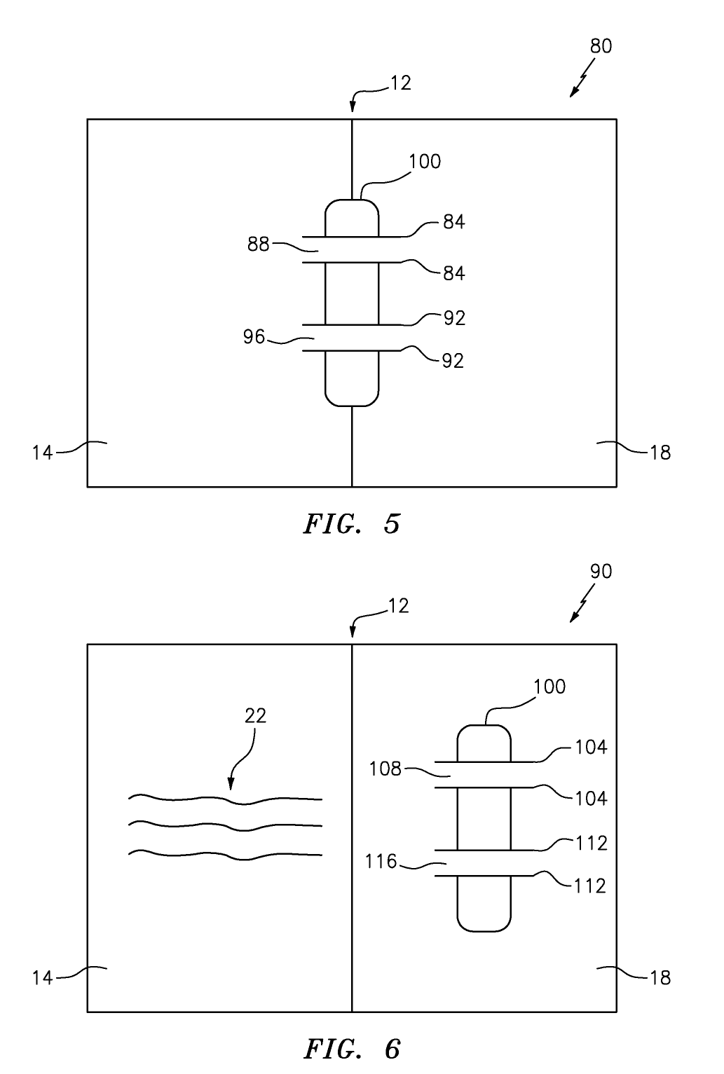

FIG. 5 shows another embodiment of the greeting card 80. In this embodiment, a first pair of slits 84 is cut into the card 80 to create a first loop 88 out of the card material. A second pair of slits 92 is cut into the card 80 to create a second loop 96 out of the card material. The loops 88, 96 can be used to slide an elongated item 100 into the loops 88, 96 and hold the item in place. The item may be a cigarette, marijuana cigarette, etc. The loops 88, 86 are aligned with the fold 12 in the embodiment shown in FIG. 5.

FIG. 6 shows another embodiment of the greeting card 90. In this embodiment, a first pair of slits 104 is cut into the card 80 to create a first loop 108 out of the card material. A second pair of slits 112 is cut into the card 80 to create a second loop 116 out of the card material. The loops 108, 116 can be used to slide an elongated item 100 into the loops 108, 116 and hold the item in place. The item may be a cigarette, marijuana cigarette, etc. The loops 108, 116 are not aligned with the fold 12, but rather or generally in the center of the right side 18 in the embodiment shown in FIG. 6.

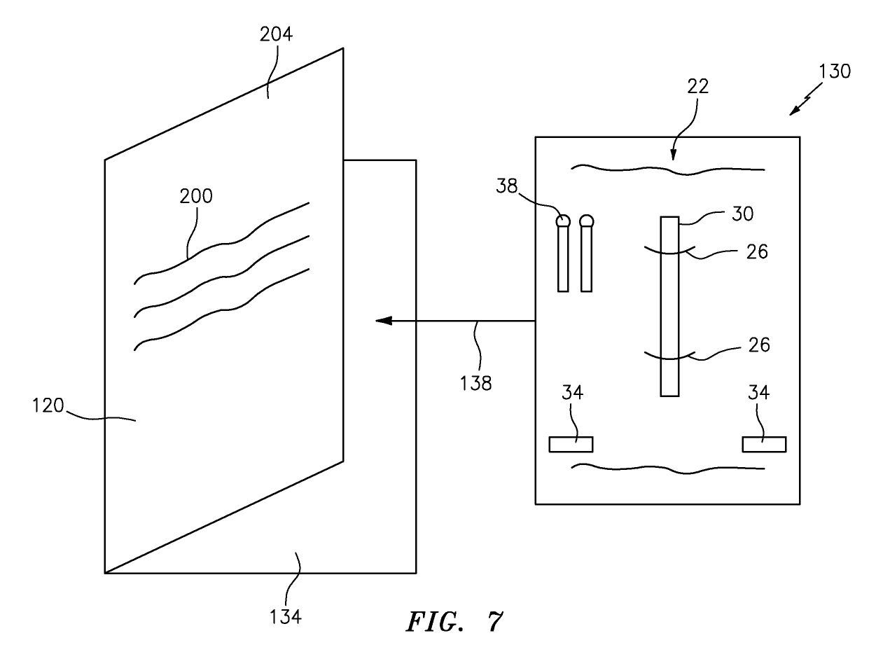

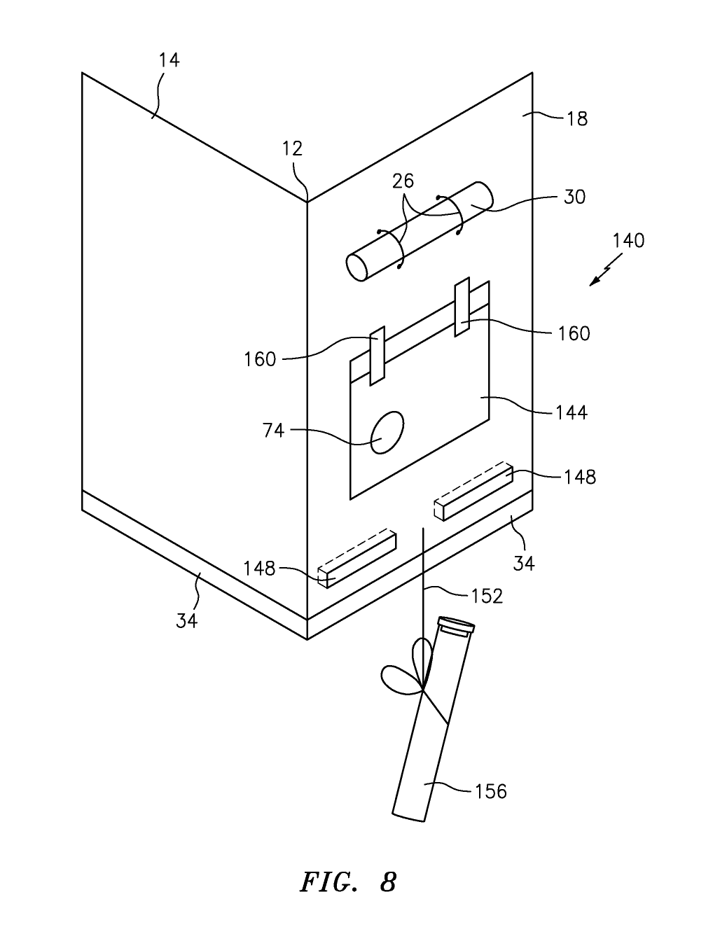

FIG. 7 shows another embodiment of the greeting card 120. In this embodiment, the greeting card 120 is configured to accept a smaller card 130. The smaller card has two loops 26 configured to hold an item 30 such as a cigarette or a marijuana cigarette.

The smaller card 130 may also be referred to as a greeting card insert 130. In one embodiment, greeting card insert 130 may be rigid and inserted into a preprinted greeting card 134 containing greeting 200 on the front 204 of the card 134. The greeting card insert 130 may be flat and smaller than the preprinted greeting card 134, and may be square, rectangular, oval, circle or any other desired shape. A preprinted greeting 22 may be located on the upper or lower portion of the greeting card insert 130. There may be one or more loops 26 attached to the greeting card insert 130. The loops 26 may be made out of an elastic material, and may be attached to the card insert 130 via adhesive, staple, other fasteners, or the card insert 130 may have a pair of small holes to allow each end of the loop 26 to go through the hole and a backing larger than the hole may be attached to each end of the loop 26 to hold the loop 26 in place with respect to the holes. The loops 26 may be configured to hold a cigarette 30. The cigarette 30 may be a tobacco cigarette, hand rolled cigarette, marijuana cigarette, or any other similarly shaped item. The card may have one or more match striking surfaces 34. Matches 38 may be provided with the greeting card insert 130. Since matches and match striking surfaces may be hazardous when mailed together, the matches may be enclosed in a container or baggie.

FIG. 8 shows another embodiment of the greeting card 140. In this embodiment, there is shown optional loops 26 holding a cigarette 30, which may be a tobacco cigarette, or a marijuana cigarette. In other embodiments, the cigarette 30 may be replaced with substitute disposable item such as a plastic straw. The substitute disposable item may simply be a place holder to allow the user to replace the substitute disposable item with the item of his or her choice. There may also or instead of, be an optional adhesive area 74. The adhesive area is configured to adhere to a baggie 144. In other embodiments, the adhesive area 74 may be replaced with a hook and loop surface and a reciprocal hook and loop surface on the baggie, configured to allow the baggie to attach to the card 140. The baggie may hold loose tobacco, marijuana, or edible treats. There may also be at least one optional container 148. The optional containers 148 may hold matches. There may be an optional cord 152 attached to the card and to a cylindrical container 156. The cylindrical container may be configured to hold tobacco or marijuana cigarettes. There may be an optional match striking surface 34 on the card. Optionally, instead of an adhesive area 74, or in addition to the adhesive area 74, fasteners 160 may be used to attach the baggie to the card 140. The fasteners may be any suitable fastener, including but not limited to staples, metal clips, clothes pins, pushpins, rivets, plastic clips, etc.

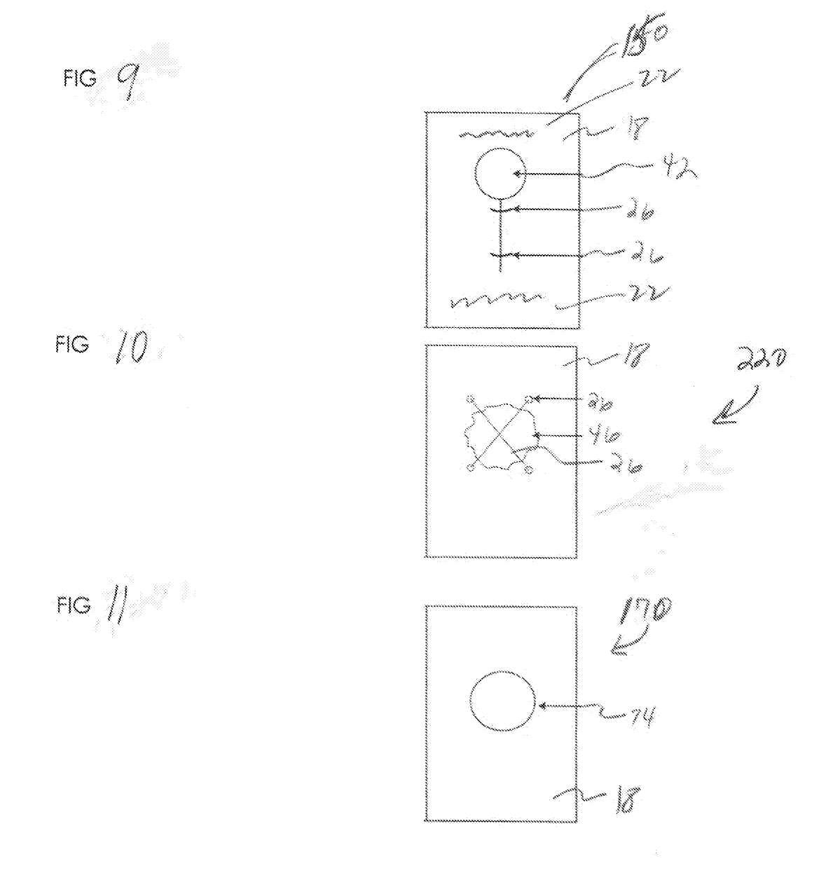

FIG. 9 shows another embodiment of the greeting card insert 150. In this embodiment, the loops 26 are configured to hold another item 42, such as a lollipop. This lollipop 42 may contain cannabis ingredients.

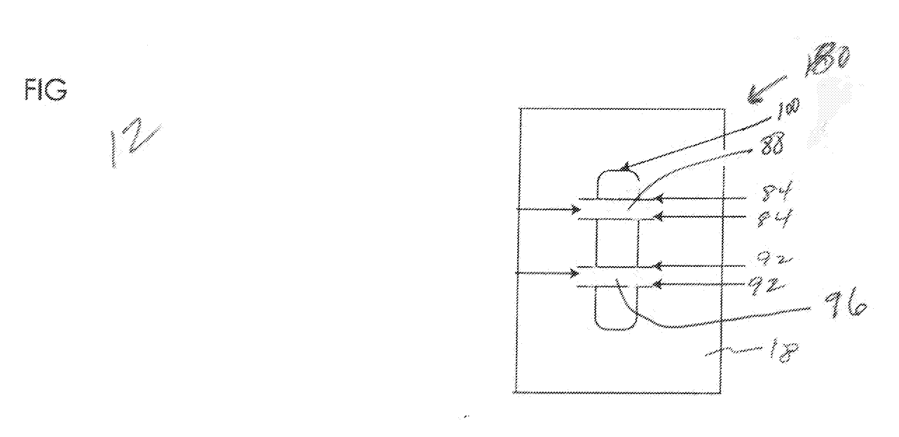

FIG. 10 shows another embodiment of the greeting card insert 220. In this embodiment, the loops 26 may be elongated and elastic, in order to better hold other shaped items 46, such as a baggie of tobacco or marijuana.

FIG. 11 shows another embodiment of the greeting card insert 170. In this embodiment, instead of loops 26, a sticky or tacky surface 74 is on the insert 170. The sticky or tacky surface 74 may have a removable paper or other material covering the surface 74 in order to preserve the sticky or tacky properties until ready for use. The sticky or tacky surface 74 may be used to hold plastic baggies filed with tobacco, marijuana, or edible treats.

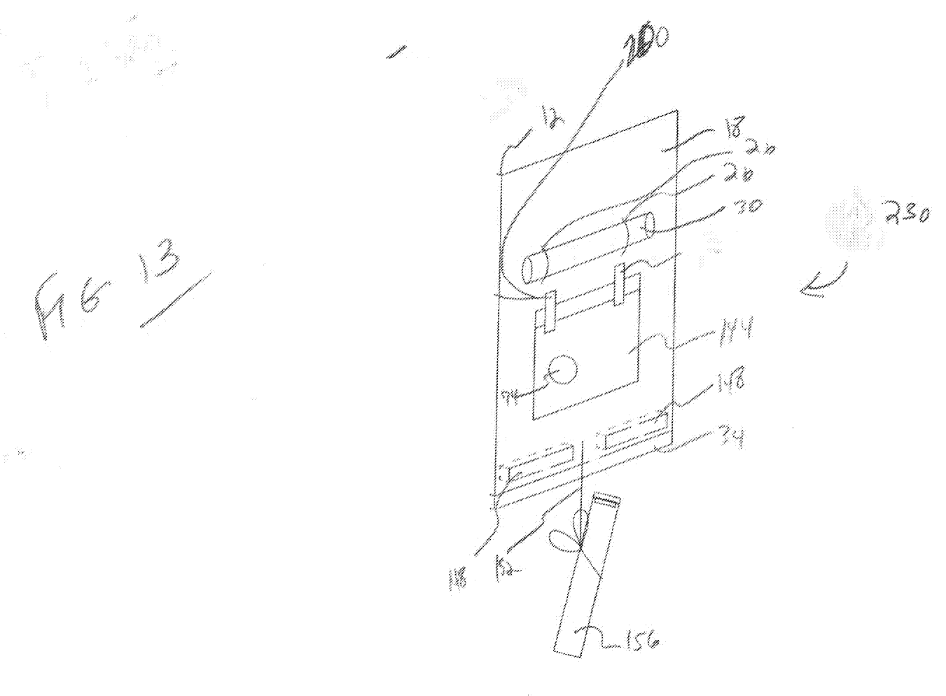

FIG. 12 shows another embodiment of the greeting card insert 180. In this embodiment, a first pair of slits 84 is cut into the insert 180 to create a first loop 88 out of the card material. A second pair of slits 92 is cut into the card insert 80 to create a second loop 96 out of the card insert material. The loops 88, 96 can be used to slide an elongated item 100 into the loops 88, 96 and hold the item in place. The item may be a cigarette, marijuana cigarette, etc.

FIG. 13 shows another embodiment of the greeting card insert 230. In this embodiment, there is shown optional loops 26 holding a cigarette 30, which may be a tobacco cigarette, or a marijuana cigarette. In other embodiments, the cigarette 30 may be replaced with substitute disposable item such as a plastic straw. The substitute disposable item may simply be a place holder to allow the user to replace the substitute disposable item with the item of his or her choice. There may be instead, or in addition, an optional adhesive area 74. The adhesive area is configured to adhere to a baggie 144. In other embodiments, the adhesive area 74 may be replaced with a hook and loop surface and a reciprocal hook and loop surface on the baggie, configured to allow the baggie to attach to the card 140. The baggie may hold loose tobacco, marijuana, or edible treats. There may also be at least one optional container 148. The optional containers 148 may hold matches. There may be an optional cord 152 attached to the card and to a cylindrical container 156. The cylindrical container may be configured to hold tobacco or marijuana cigarettes. There may be an optional match striking surface 34 on the greeting card insert 230. Optionally, instead of an adhesive area 74, or in addition to the adhesive area 74, fasteners 160 may be used to attach the baggie to the card 140. The fasteners may be any suitable fastener, including but not limited to staples, metal clips, clothes pins, pushpins, rivets, plastic clips, etc.

This invention can solve not having a match and or match strike readily available. The greeting card may be provided with two matches and two match strikers on the card. This allows the greeting card to always have two matches and a surface to light the matches on.

One could make the disclosed greeting card by graphically designing a greeting card. Then by manufacturing through a printing process. The 5″ by 7″ cards, in one non-limiting embodiment, may then be folded. The matches and match strikers are then applied to the card with adhesive glue.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A greeting card, the greeting card comprising:
a left side;
a fold abutting the left side;
a right side abutting the fold;
an attachment means located on the left side or right side; and
a smoking related product configured to removably attach to the attachment means.

2. The greeting card of claim 1, wherein the smoking related product is selected from the group consisting of a tobacco cigarette, hand rolled cigarette, marijuana cigarette, matches, container of tobacco, and a container of marijuana.

3. The greeting card of claim 1, wherein the attachment means is a loop.

4. The greeting card of claim 3, wherein the loop an elastic loop.

5. The greeting card of claim 1, wherein the attachment means is a tacky surface.

6. The greeting card of claim 1, wherein the attachment means is a plurality of loops.

7. The greeting card of claim 1, further comprising a match striking surface located on the left side or right side.

8. A greeting card, the greeting card comprising:
an outer greeting card, the outer greeting card comprising:
a left side;
a fold abutting the left side;
a right side abutting the fold;
a greeting card insert configured to generally fit inside the outer greeting card, the greeting card insert comprising:
an attachment means, the attachment means configured to hold a smoking related product.

9. The greeting card insert of claim 8, wherein the smoking related product is selected from the group consisting of a tobacco cigarette, hand rolled cigarette, marijuana cigarette, matches, container of tobacco, and a container of marijuana.

10. The greeting card of claim 8, wherein the attachment means is a loop.

11. The greeting card insert of claim 10, wherein the loop an elastic loop.

12. The greeting card of claim 8, wherein the attachment means is a tacky surface.

13. The greeting card of claim 8, wherein the attachment means is a plurality of loops.

14. The greeting card of claim 8, wherein the greeting card insert further comprising a match-striking surface.

16. The greeting card of claim 8, wherein the outer greeting card is a holiday card.

17. The greeting card of claim 8, wherein the outer greeting card is a holiday card, where the holiday is selected from the group consisting of Christmas, Hanukah, Easter, and Thanksgiving.

18. A greeting card insert, the greeting card insert comprising:
a generally rectangular card stock; and
an attachment means located on the generally rectangular card stock, the attachment means configured to hold a smoking related product.

19. The greeting card insert of claim 18, wherein the greeting card insert is configured to generally fit inside an outer greeting card.

20. The greeting card insert of claim 18, wherein the greeting card insert is configured to be insertable into an object, the object selected from the group consisting of a letter, an envelope, and folded literature.
